(19) United States
(12) Patent Application Publication
(10) Pub. No.: US 2026/0250045 A1
(43) Pub. Date: Aug. 27, 2026

(54) CONTAINER WITH INTEGRATED POUR SPOUT

(71) Applicant: BWAY CORPORATION, Oak Brook, IL (US)

(72) Inventors: William LaDon Hopkins, Pine Mountain, GA (US); Jim Gurski, Anderson Township, OH (US)

(21) Appl. No.: 19/548,278

(22) Filed: Feb. 24, 2026

Related U.S. Application Data
(60) Provisional application No. 63/763,187, filed on Feb. 25, 2025.

(51) Int. Cl. B65D 25/42; B44D 3/12; B65D 25/32; B65D 43/02

(52) U.S. Cl. CPC B65D 25/42; B44D 3/12; B65D 25/32; B65D 43/0216; B65D 2543/00092; B65D 2543/00462

(57) ABSTRACT

A container configured to hold liquid contents includes a sidewall defining a longitudinal axis having a first end and a second end opposite the first end, and a base coupled to the sidewall adjacent the first end. The sidewall and the base define a cavity. The container further includes a rim coupled to the sidewall adjacent the second end. The rim defines a plane that intersects the longitudinal axis. The container further includes a lid removably coupled to the rim to selectively enclose the cavity and a pour spout coupled to the rim and positioned entirely below the plane along the longitudinal axis. The lid includes a face configured to align with the plane.

### CROSS-REFERENCE TO RELATED APPLICATIONS

This application claims priority to U.S. Provisional Patent Application No. 63/763,187, filed Feb. 25, 2025, the entire contents of which are incorporated herein by reference.

### FIELD

The present disclosure relates to containers, and more specifically, to containers that hold fluid such as paint.

### BACKGROUND

Paint is commonly packaged, stored, and sold in paint containers. Paint containers, typically composed of metal, plastic, or a combination of both, are formed in various shapes and sizes. A handle is typically provided to carry the container, and a lid is coupled to the container to enclose the paint.

### SUMMARY

One aspect of the present disclosure relates to a container configured to hold liquid contents, the container including a sidewall defining a longitudinal axis having a first end and a second end opposite the first end; a base coupled to the sidewall adjacent the first end, the sidewall and the base defining a cavity; a rim coupled to the sidewall adjacent the second end, the rim defining a plane that intersects the longitudinal axis; a lid removably coupled to the rim to selectively enclose the cavity, the lid including a face configured to align with the plane; and a pour spout coupled to the rim and positioned entirely below the plane along the longitudinal axis.

Another aspect of the present disclosure relates to a container configured to hold liquid contents, the container including a base; a sidewall extending upward from the base and defining a longitudinal axis; a rim coupled to the sidewall opposite from the base and configured to selectively receive a lid removably coupled thereto, the rim including a lip defining an outer periphery of the rim, a channel disposed radially inward from the lip, and a rim projection disposed radially inward from the channel, an end of the rim projection defining a plane transverse to the longitudinal axis; and a pour spout integrally formed with the rim and disposed entirely between the plane and the base along the longitudinal axis, the pour spout configured to convey the liquid contents over the lip during pouring.

Still another aspect of the present disclosure relates to a container to a container configured to hold liquid contents, the container including a cavity defined by a base and a sidewall coupled to the base; a rim disposed adjacent the cavity, the rim including a lip, a channel extending inward from the lip, a rim projection extending inward from the channel; a lid removably coupled to the rim to selectively enclose the cavity, the lid including a face and a lid projection, the face contacted by the rim projection, the lid projection received in the channel when the lid is coupled to the rim; and a pour spout coupled to the rim below and out of contact with the lid when the lid is coupled to the rim.

Other aspects will become apparent by consideration of the detailed description and accompanying drawings.

### BRIEF DESCRIPTION OF THE DRAWINGS

FIG. 1 is a perspective view of a container in accordance with an embodiment of the disclosure.

FIG. 2 is a cross-sectional view of the container along line 2-2 of FIG. 1, illustrating a lid removed from a rim of the container.

FIG. 3 is a cross-sectional view of the container along line 2-2 of FIG. 1, illustrating the lid coupled to the rim of the container.

FIG. 4 is a top plan view of the container of FIG. 1, illustrating a pour spout integrated into the rim.

FIG. 5 is a perspective view of the container of FIG. 1 without a flange.

FIG. 6 is a perspective view of a container in accordance with another embodiment of the disclosure.

FIG. 7 is an enlarged perspective view of the container of FIG. 6, illustrating a pour spout with a flange and an apron.

FIG. 8 is a perspective view of the container of FIG. 6, illustrating liquid contents within the container flowing out through the pour spout.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

The present disclosure includes examples of the disclosed technology, particularly example containers including a pour spout. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known structures or techniques are not necessarily shown in detail.

The disclosed technology will be described more fully hereinafter with reference to the accompanying drawings. This disclosed technology can, however, be embodied in many different forms and should not be construed as limited to the examples set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

In the following description, numerous specific details are set forth. But it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

To the extent any aspects of the disclosed technology are presented in a range of formats (e.g., a range of values), it is to be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, any ranges disclosed herein are inclusive of the respective endpoints, unless otherwise indicated.

Herein, the use of terms such as “having,” “has,” “including,” or “includes” are open ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential.

The terms “approximately” and “about,” as used herein, refer to slight variations of the specified values. These variations may occur due to manufacturing tolerances, measurement limitations, or inherent variability in conditions, and should be understood to allow for a reasonable margin of error that would not materially affect the disclosed technology or its operation. Unless otherwise indicated, such terms generally encompass a range of ±10% of the referenced value.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

Additional objects, advantages, and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

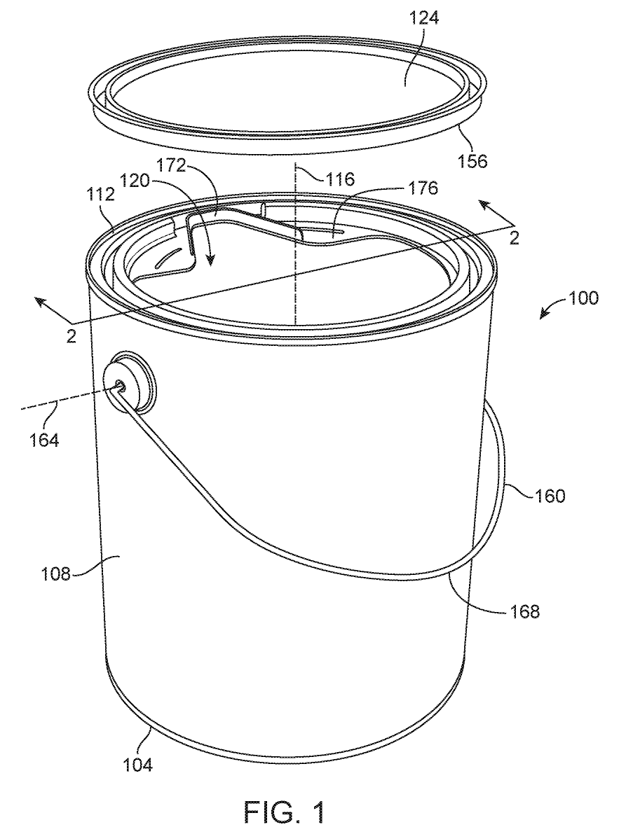

FIG. 1 illustrates a container 100 (e.g., a paint container) that is configured to hold and store fluids, such as paints, stains, lacquers, varnishes, sealers, clear coats, etc. The container 100 includes a base 104, a cylindrical sidewall 108 extending upward from the base 104, and a rim 112 coupled to the sidewall 108 opposite the base 104. In the illustrated embodiment, the base 104, the sidewall 108, and the rim 112 are all separate components that are coupled together via various mechanical means. For example, the base 104 and the rim 112 are each coupled to the sidewall 108 via a crimped, folded, or seamed joint. In other embodiments, however, the base 104, the sidewall 108, and the rim 112 may alternatively be coupled together via adhesives, welding, or other similar joining means. Still, in other embodiments, the base 104, the sidewall 108, and the rim 112 may alternatively be integrally formed together to form a single, monolithic component.

The container 100 of the illustrated embodiment can be composed of metal, but may alternatively be composed of plastic or a combination of plastic and metal. Stated differently, the container 100 can comprise one or more metal components, one or more plastic components, or any combination thereof. Furthermore, while the illustrated container 100 is generally cylindrical in shape, the disclosed technology is not so limited and the container 100 can have any shape. For example, the container 100 can have a generally rectangular cross-sectional shape (e.g., with rounded comers), a generally square cross-sectional shape (e.g., with rounded comers), a different polygonal cross-sectional shape, or any other cross-sectional shape.

With continued reference to FIG. 1, the cylindrical sidewall 108 defines a longitudinal axis 116 that extends centrally relative to the sidewall 108. That is, the longitudinal axis 116 extends offset from, and parallel to, the sidewall 108 along a direction from the base 104 toward the rim 112. Stated another way, the longitudinal axis 116 has a first end adjacent the base 104 and a second opposite end adjacent the rim 112. The longitudinal axis 116 can extend through a center point of the base 104 and a center point of the rim 112.

The container 100 includes a cavity 120 that is collectively formed by the base 104 and the sidewall 108. The cavity 120 of the illustrated embodiment defines a volume of approximately 1 gallon, while in other embodiments, the cavity 120 may define a volume less than or greater than 1 gallon. Thus, the container 100 of the illustrated embodiment is a 1-gallon paint can. To selectively enclose the cavity 120, a lid 124 can be coupled to the rim 112, as described in further detail below.

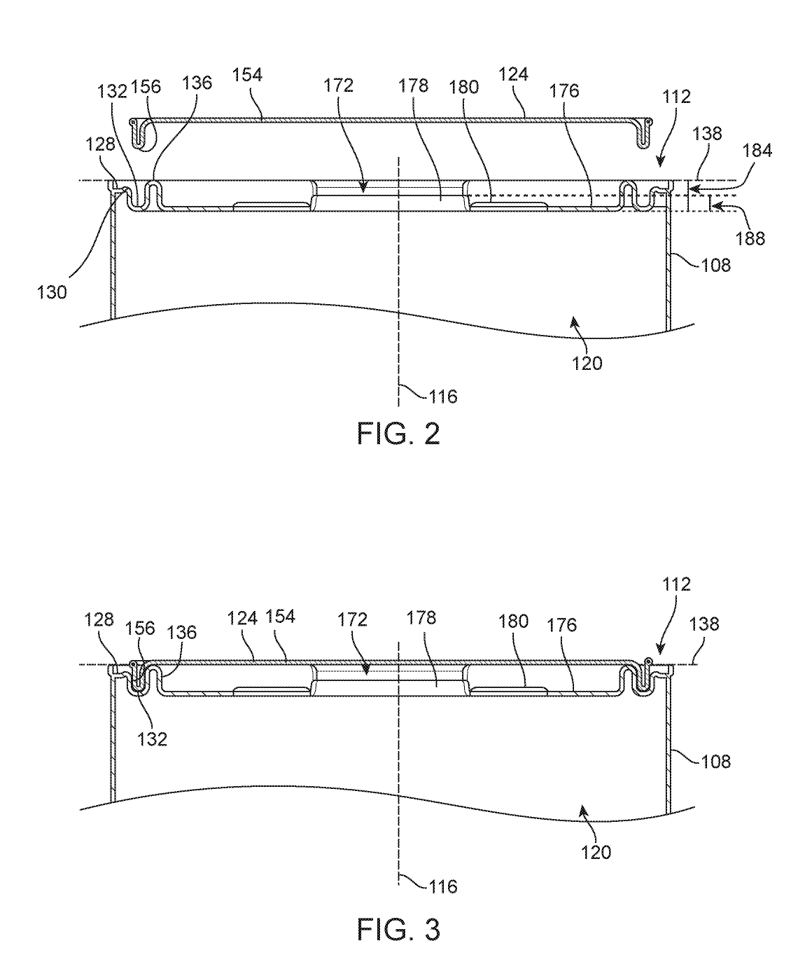

With reference to FIGS. 2 and 3, the rim 112 includes a lip 128 that at least partially protrudes or extends radially outward from the sidewall 108 and defines the outer periphery (e.g., outermost portion) of the rim 112. The rim 112 may also include a shoulder 130 extending from the lip 128. As a non-limiting example, the lip 128 can be formed as a result of part of the rim 112 being folded over a flange of the sidewall 108 (e.g., to create a liquid-tight seal therebetween). The rim 112 can include a channel 132 that extends downwardly from the lip 128 (e.g., in a direction towards the base 104 of the container 100). The channel 132 is disposed radially inward relative to the lip 128 and can extend annularly about the longitudinal axis 116. In other words, the channel 132 can extend annularly fully (e.g., 360 degrees) about the longitudinal axis 116. Alternatively, in some embodiments, the channel 132 can extend annularly about some, but not all, of the longitudinal axis 116. Stated differently, the channel 132 can extend along a portion of the rim's 112 perimeter, but another portion of the rim's 112 perimeter can omit the channel 132.

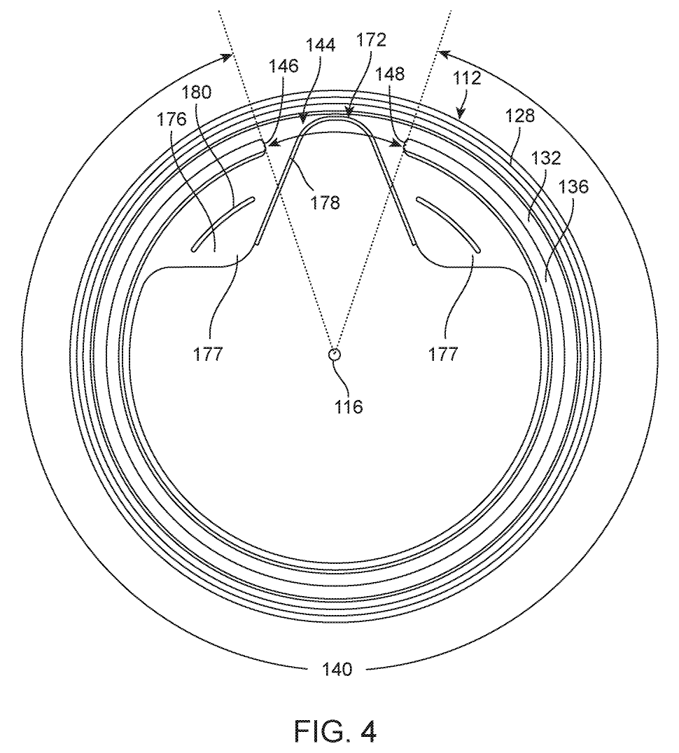

The rim 112 can include a rim projection 136 disposed radially inward (e.g., positioned radially nearer) relative to the channel 132. The rim projection 136 can extend upwardly from the channel 132 to approximately the same height as the lip 128. That is, the lip 128 and the rim projection 136 can be positioned at approximately the same height from the base 104 as measured along a direction parallel to the longitudinal axis 116. In one example instance, a peak (e.g., top, uppermost point) of the lip 128 and a peak (e.g., top, uppermost point) of the rim projection 136 can abut a plane 138 that defines the top (e.g., uppermost point(s)) of the container 100. Furthermore, the rim projection 136 can extend along a curve (e.g., circumferential path), such as an arcuate path 140 (FIG. 4) revolved around the longitudinal axis 116 and terminating at two opposing ends 146, 148. The arcuate path 140 can have an arc length that is less than 360 degrees. Generally, the plane 138 is angularly offset from the longitudinal axis 116. In the illustrated embodiment, the plane 138 is transverse to the longitudinal axis 116. In some example instances, the plane 138 is orthogonal, normal, or slanted relative the longitudinal axis 116.

Alternatively and/or additionally, the arcuate path 140 can have an arc length that is greater than approximately 340 degrees, and/or the arcuate path 140 can have an arc length that is less than approximately 355 degrees. Stated differently, the arcuate path 140 can have an arc length (e.g., revolve around the longitudinal axis 116) that is in a range from approximately 340 degrees to approximately 355 degrees. As a result, a gap 144 exists between the two opposing ends 146, 148 of the rim projection 136 (e.g., where the rim projection 136 is not adjacent the channel 132). Accordingly, the gap 144 can make up what the arcuate path 140 leaves open (e.g., the gap 144 can extend around approximately 20 degrees to approximately 5 degrees of the rim 112).

While the term “arcuate” has been used to describe the arcuate path 140, the disclosed technology is not so limited, and the rim projection can follow a path 140 of any desired shape. For example, the rim projection can follow a path 140 that has a shape the same as, or similar to (e.g., approximately the same as), the cross-sectional shape of the container 100. Further, at least the portion of the rim's 112 perimeter that corresponds to an arc length of the of the pour spout 172 can omit the channel 132. Alternatively and/or additionally, the portion of the rim's 112 perimeter that corresponds to the arc length of the of the pour spout 172 and omits the channel 132 can be approximately the same as the arc length of the gap 144.

As perhaps best illustrated in FIG. 3, the channel 132 is configured to receive a portion of the lid 124 when the lid 124 is coupled to the rim 112. Specifically, the lid 124 includes a face 154 and a lid projection 156 that is at least partially received within the channel 132 when the lid 124 is coupled to the rim 112. The lid projection 156 can be press-fit into the channel 132, such that there is some mechanical interference between the channel 132 and the lid projection 156. However, one or both of the channel 132 and the lid projection 156 can deform slightly to accommodate the other when a sufficient force is exerted via pressing the lid 124 onto the container 100. This forms a liquid-tight connection between the lid 124 and the container 100 to inhibit any inadvertent leakage of liquid (e.g., paint) from the container 100. Generally, the face 154 is sized and shaped to align with the plane 138 when the lid 124 is coupled to the rim 112.

The container 100 further includes a handle 160 that is pivotably coupled to the sidewall 108 about a pivot axis 164. The pivot axis 164 is oriented perpendicular to the longitudinal axis 116. The handle 160 is a wire handle that may pivot toward and rest against the sidewall 108 when not being used. In contrast, the handle 160 defines a gripping region 168 that is disposed above the container 100 when a user is carrying and maneuvering the container 100.

With additional reference to FIG. 4, the container 100 further includes a pour spout 172 that is integrally formed with the rim 112. That is, the rim 112 includes the pour spout 172. The pour spout 172 funnels and directs liquid contents (e.g., paint) through the gap 144 of the rim 112 when a user tips the container 100 to pour paint from the container 100. The pour spout 172 extends through a portion of the channel 132 adjacent the gap 144, such that paint flowing through the pour spout 172 travels directly over the lip 128 of the rim 112 to inhibit paint from collecting (e.g., pooling) in the channel 132.

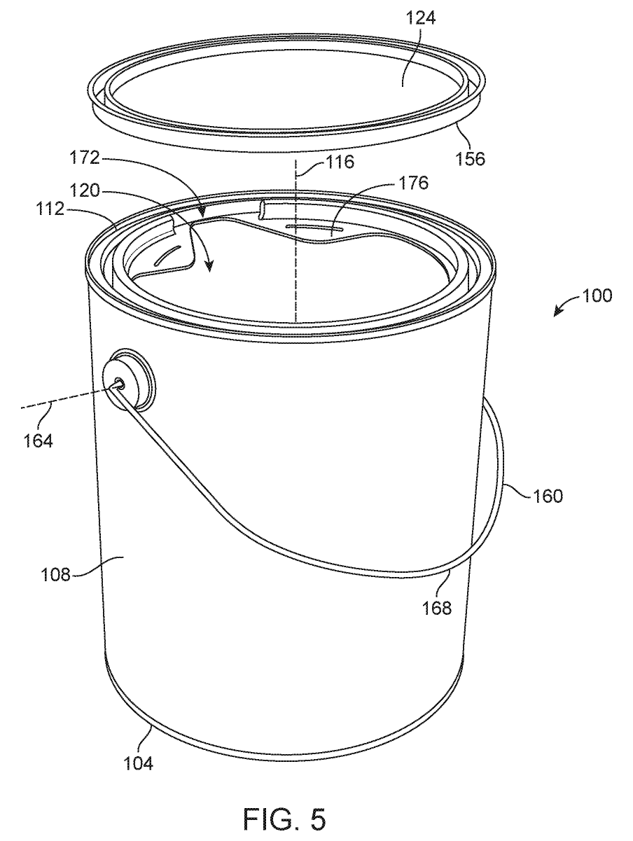

As illustrated in FIGS. 1-4, the pour spout 172 includes an apron 176 that extends radially inward from the rim projection 136, or from an outer perimeter of the rim 112, towards the longitudinal axis 116. The pour spout 172 and/or apron 176 also includes a flange 178 that extends away (e.g., upwardly) from the apron 176 along a direction generally parallel to the longitudinal axis 116 toward the rim 112. The flange 178 may be positioned adjacent an opening of the pour spout 172 to provide additional direction control and/or extend a fluid path for liquid being poured (e.g., conveyed, emptied, etc.), as detailed below shortly. As illustrated in FIG. 5, however, the flange 178 may be omitted. In some instances, the flange 178 is integrally formed with the pour spout 172 and/or the apron 176 as a singe monolithic piece. In other instances, the flange 178 is coupled (e.g., fastened, attached, connected, etc.) to the pour spout 172 and/or apron 176. In some example embodiments, the flange 178 is rigid (e.g., solid, not foldable, not collapsible, etc.).

Generally, the apron 176 serves to limit the amount of paint being poured through the pour spout 172, particularly when the container 100 is tipped at more severe angles (e.g., greater than 100 degrees from the upright or vertical orientation of the container 100, greater than 110 degrees from the vertical orientation of the container 100, greater than 120 degrees from the vertical orientation of the container 100).

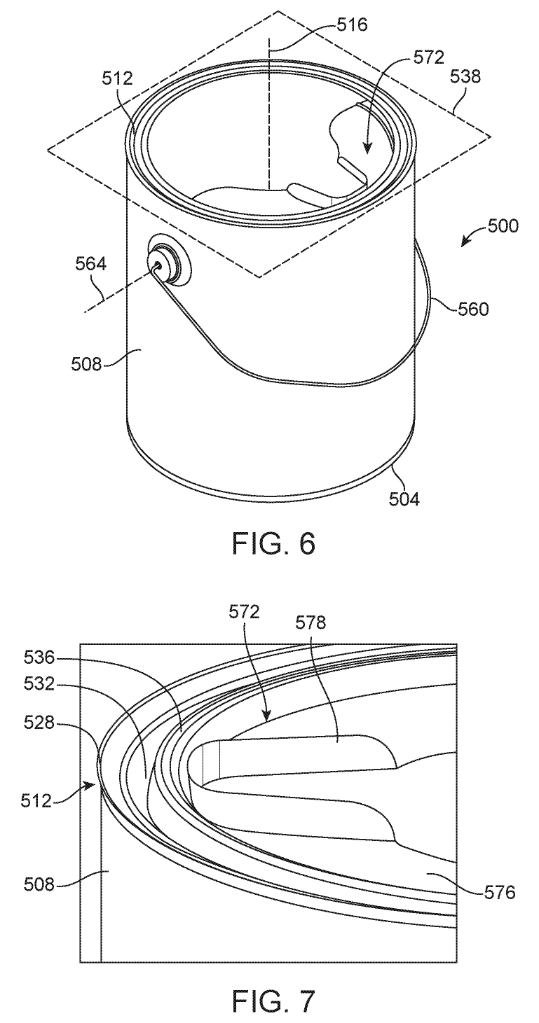

The rim 112 can be stamped (e.g., cut) as a single, monolithic component and subsequently pressed into shape, such that the lip 128, the channel 132, the rim projection 136, the pour spout 172, and/or the apron 176 are formed together. The illustrated apron 176 is oriented substantially perpendicular to the longitudinal axis 116, such that any paint on a topside of the apron 176 may be wiped or brushed back into the container 100. However, in other embodiments, as described in further detail below, the apron 176 may alternatively slope downward along a direction from the rim projection 136 toward the longitudinal axis 116, such that paint on the topside of the apron 176 may automatically drip back into the container 100 under gravity (e.g., when the container 100 is returned to the vertical position), as shown in FIG. 6.

The apron 176 can further include one or more ribs 180 (e.g., a pair of ribs 180), which can increase rigidity and overall strength of the apron 176, especially when the apron 176 restricts (e.g., limits) and/or directs paint flow (or the flow of another liquid) through the pour spout 172. Although a pair of ribs 180 are disposed on the apron 176 in the illustrated embodiment, in other embodiments, there may be fewer or greater than a pair of ribs 180. The apron 176 may even further include leaves 177 that at least partially define a portion of the pour spout 172. In one example instance, the ribs 180 are positioned on the leaves 177.

With returned reference to FIGS. 2 and 3, the pour spout 172 and the apron 176 are disposed entirely underneath the lid 124 when the lid 124 is coupled to the rim 112. In one example instance, the pour spout 172 and the apron 176 are also disposed entirely underneath the lip 128 and the rim projection 136, meaning that the pour spout 172 and the apron 176 do not extend above – or beyond – the lip 128 of the rim 112, particularly along the longitudinal axis 116. In other words, the pour spout 172 and the apron 176 are entirely disposed on one side of the plane 138 that defines the top of the container 100. That is, the pour spout 172 and the apron 176 are spaced away from the plane 138 along a direction parallel to the longitudinal axis 116. The pour spout 172 and the apron 176 are also entirely disposed below the face 154 of the lid 12, when the lid 124 is coupled to the container 100.

As further illustrated in FIGS. 2 and 3, the flange 178 extends from the apron 176 toward the plane 138 along a direction generally parallel to the longitudinal axis 116. In one example instance, the rim projection 136 extends towards the second end of the longitudinal axis 116 (e.g., towards the plane 138) by a first amount 184, and the flange 178 extends towards the second end of the longitudinal axis 116 (e.g., towards the plane 138) by a second amount 188 that is less than the first amount 184. In one arrangement, the rim projection 136 extends by twice the amount of the flange 178.

In other embodiments, as illustrated below, the flange 178 may extend from the apron 176 toward the plane 138 along a direction generally parallel to the longitudinal axis 116 to approximately the same height as the lip 128 and/or the rim projection 136. Furthermore, the flange 178 is generally shaped to follow an opening (e.g., profile, contour, etc.) of the pour spout 172 and have a uniform height. However, in some instances, the flange 178 may extend from the apron 176 by lesser or greater amounts at different locations around the pout spout 172. In some instances, the flange 178 may extend towards the first end of the longitudinal axis 116 (e.g., away from the plane 138). In further instances, the shoulder 130 may extend along the longitudinal axis 116 by an amount between the first amount 188 and the second amount 184.

With continued reference to FIG. 4, the pour spout 172 and/or flange 178 may be generally U-Shaped. In other example arrangements, the pour spout 172 and/or flange 178 may have another shape, such as a slit, slot, triangle, and/or the like. The pour spout 172 may extend into the channel 132 to at least partially delineate the channel 132. Similarly, the pour spout 172 may extend into the gap 144 between the two ends 146, 148 of the rim projection 136, such that the height of the rim projection 136 gives the flange 178 some space to extend upwardly without the flange 178 crossing the plane 138. Further, because the flange 178 extends upwardly by some distance, liquid being poured from the pour spout 172 more easily reaches over an outermost edge (e.g., periphery) of the container 100 defined by at least one of the sidewall 108 and the rim 112.

FIGS. 6-8 illustrate a container 500 (e.g., a paint container) according to another embodiment of the disclosed technology. The illustrated container 500 in FIGS. 5-7 includes similar structure as the container 100 illustrated in FIGS. 1-4. Common functional elements have been given the same reference numbers plus 400, and the following description focuses primarily on differences in structure between the pour spout 172 and a pour spout 572.

With reference to FIG. 6, the container 500 includes a base 504, a cylindrical sidewall 508 extending upward from the base 504, and a rim 512 coupled to the sidewall 508 opposite the base 504. The cylindrical sidewall 508 defines a longitudinal axis 516 that extends centrally relative to the sidewall 508. That is, the longitudinal axis 516 extends offset and parallel to the sidewall 508 along a direction from the base 504 toward the rim 512.

With continued reference of FIG. 6, the rim 512 includes a lip 528 that defines the outermost periphery of the rim 512. The rim 512 further includes a channel 532 that extends downward from the lip 528 toward the base 504 of the container 500. The channel 532 is disposed radially inward relative to the lip 528 and revolves about the longitudinal axis 516. In other words, the channel 532 can extend annularly fully (e.g., 360 degrees) about the longitudinal axis 516. The rim 512 also includes a rim projection 536 that is disposed radially inward relative to the channel 532.

Similar to the channel 532, the rim projection 536 can extend annularly fully (e.g., 360 degrees) about the longitudinal axis 516. The rim projection 536 can extend upward from the channel 532 to approximately the same height as the lip 528. That is, the lip 528 and the rim projection 536 can be approximately the same height from the base 504 as measured along a direction parallel to the longitudinal axis 516. In one example instance, a peak (e.g., top, uppermost point) of the lip 528 and a peak (e.g., top, uppermost point) of the rim projection 536 can abut a plane 538 that defines the top of the container 500.

The lid 124 is configured to couple to the container 500. Specifically, the channel 532 is configured to receive the lid projection 156 of the lid 124 when the lid 124 is coupled to the rim 512 in the same manner as previously described when the channel 132 receives the lid 124.

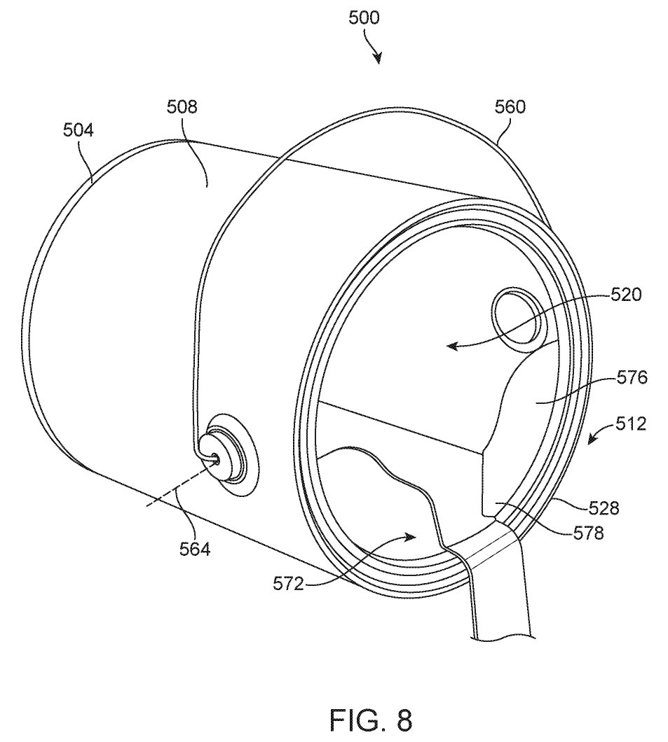

With reference to FIGS. 6 and 7, the rim 512 includes the pour spout 572. The pour spout 572 can be integrally formed with the rim 512. As best illustrated in FIG. 8, the pour spout 572 funnels and directs liquid contents (e.g., paint) directly over the lip 528 and/or the rim projection 536 to inhibit paint from collecting (e.g., pooling) in the channel 532. The pour spout 572 can include an apron 576 and a flange 578 that extends upward from the apron 576 around the opening of the pour spout 572. The apron 576 extends radially inward toward the longitudinal axis 516 from the rim projection 536 and/or from the outer perimeter of the rim 512.

Further, the apron 576 serves to limit the amount of paint being poured through the pour spout 572. The rim 512 can be stamped (e.g., cut) as a single, monolithic component and subsequently pressed into shape, such that the lip 528, the channel 532, the rim projection 536, the pour spout 572, and/or the apron 576 are formed together. The illustrated apron 576 slopes downward (e.g., in a direction from the rim 512 to the base 504) and radially inward (e.g., in a direction from the rim projection 536 toward the longitudinal axis 516 (FIG. 6)), such that paint on a topside of the apron 576 can be automatically directed to drip back into the container 500 under gravity (e.g., when the container 100 is returned to the vertical position). The apron 576 may further include one or more strengthening bodies, such as ribs, to increase rigidity and/or overall strength of the apron 576.

With returned reference to FIG. 6, the pour spout 572 and the apron 576 are disposed entirely underneath the lid 124 when the lid 124 is coupled to the rim 512. In one example instance, the pour spout 572 and the apron 576 are also disposed entirely underneath the lip 528 and the rim projection 536, meaning that the pour spout 572 and the apron 576 do not extend above – or beyond – the lip 528 of the rim 512. In other words, the pour spout 572 and the apron 576 are entirely disposed on one side of the plane 538 that defines the top of the container 100. The apron 576 is spaced away from the plane 538 along a direction substantially parallel to the longitudinal axis 116. The flange 578, however, extends from the apron 576 toward the plane 538 along a direction generally parallel to the longitudinal axis 516 to approximately the same height as the lip 528 and the rim projection 536.

During operation, a user removes the lid 124 from the rim 112, 512 of the container 100, 500 by prying off the lid 124 with, for example, a flat head screwdriver or other suitable tool. At that point, the cavity 120, 520 of the container 100, 500 is accessible, and the liquid contents therein may be discharged. Subsequently, a user grasps the handle 160, 560 with one hand (e.g., left hand) and with the other hand (e.g., right hand) pivots the container 100, 500 about the pivot axis 164, 564 until liquid contents (e.g., paint) begin pouring out of the container 100, 500 via the pour spout 172, 572. Depending on the flow rate of the paint flowing through the pour spout 172, 572, the paint may project outwardly along a trajectory that altogether avoids contact with the lip 128, 528 of the rim 112, 512. Once the desired amount of paint is discharged from the container 100, 500, the user may pivot the container 100, 500 upright again and recouple the lid 124 to the container 100, 500.

While the various examples provided herein have largely described the disclosed technology with reference to a container 100, 500 that includes a rim 112, 512, the disclosed technology is not so limited. For example, it is to be understood that the disclosed technology includes a rim 112, 512 or other structure having a pour spout 172, 572, and such rim 112, 512 or other structure can be attachable to a container body, to thereby provide a container that is the same as, or similar to the container 100, 500 described herein.

Although the container has been described in detail with reference to certain preferred embodiments, variations and modifications exist within the scope and spirit of one or more independent aspects of the disclosure as described.

Various features of the present disclosure are set forth in the following claims.

What is claimed is:

1. A container configured to hold liquid contents, the container comprising:
a sidewall defining a longitudinal axis having a first end and a second end opposite the first end;
a base coupled to the sidewall adjacent the first end, the sidewall and the base defining a cavity;
a rim coupled to the sidewall adjacent the second end, the rim defining a plane that intersects the longitudinal axis;
a lid removably coupled to the rim to selectively enclose the cavity, the lid including a face configured to align with the plane; and
a pour spout coupled to the rim and positioned entirely below the plane along the longitudinal axis.

2. The container of claim 1, wherein the sidewall defines an outermost periphery of the container, and wherein the rim includes an annular lip extending radially inward from the sidewall.

3. The container of claim 2, wherein the rim further includes an annular channel extending from the annular lip away from the second end.

4. The container of claim 3, wherein the rim further includes a rim projection coupled to the annular channel and extending toward the second end by a first amount.

5. The container of claim 4, wherein the pour spout includes a flange extending towards the second end by a second amount that is less than the first amount.

6. The container of claim 3, wherein the annular channel extends continuously about the longitudinal axis.

7. The container of claim 6, wherein the rim further includes a rim projection positioned radially nearer than the annular channel to the longitudinal axis, and wherein the rim projection extends around the longitudinal axis between opposing ends.

8. The container of claim 7, wherein at least a portion of the pour spout is positioned between the opposing ends of the rim projection.

9. The container of claim 1, wherein the lid includes a lid projection extending away from the face, and wherein the lid projection and the face are positioned on opposite sides of the plane.

10. The container of claim 9, wherein the pour spout includes a flange extending towards the plane, and wherein the flange and the lid projection are positioned on a common side of the plane.

11. A container configured to hold liquid contents, the container comprising:
a base;
a sidewall extending upward from the base and defining a longitudinal axis;
a rim coupled to the sidewall opposite from the base and configured to selectively receive a lid removably coupled thereto, the rim including
a lip defining an outer periphery of the rim,
a channel disposed radially inward from the lip, and
a rim projection disposed radially inward from the channel, an end of the rim projection defining a plane transverse to the longitudinal axis; and
a pour spout integrally formed with the rim and disposed entirely between the plane and the base along the longitudinal axis, the pour spout configured to convey the liquid contents over the lip during pouring.

12. The container of claim 11, wherein the rim projection extends along an arcuate path about the longitudinal axis from a first end to a second end, and wherein a space between the first end and the second end defines a gap.

13. The container of claim 12, wherein the pour spout includes a flange extending away from the base along the longitudinal axis and positioned within the gap.

14. The container of claim 12, wherein the arcuate path extends around approximately 340 degrees to approximately 355 degrees of the rim.

15. The container of claim 12, wherein the gap extends around approximately 20 degrees to approximately 5 degrees of the rim.

16. The container of claim 11, further comprising a handle pivotably coupled to the sidewall.

17. A container configured to hold liquid contents, the container comprising:
a cavity defined by a base and a sidewall coupled to the base;
a rim disposed adjacent the cavity, the rim including a
a lip,
a channel extending inward from the lip,
a rim projection extending inward from the channel;
a lid removably coupled to the rim to selectively enclose the cavity, the lid including a face and a lid projection, the face contacted by the rim projection, the lid projection received in the channel when the lid is coupled to the rim; and
a pour spout coupled to the rim below and out of contact with the lid when the lid is coupled to the rim.

18. The container of claim 17, wherein the pour spout includes a rigid flange extending upwardly therefrom to convey the liquid contents over the lip during pouring.

19. The container of claim 18, wherein the pour spout and the rigid flange are substantially U-shaped.

20. The container of claim 19, wherein the rim projection extends upwardly by a first amount to contact the lid when the lid is coupled to the rim, and wherein the rigid flange extends upwardly by a second amount that is less than the first amount.
